(19) United States
(12) Patent Application Publication
(10) Pub. No.: US 2005/0286845 A1
(43) Pub. Date: Dec. 29, 2005

(54) Fiberoptic device for dental or industrial use

(76) Inventor: John R. Plocharczyk, Enfield, CT (US)

Correspondence Address: MCCARTER & ENGLISH LLP;CITYPLACE I, 185 ASYLUM STREET, HARTFORD, CT, 06103, US

(21) Appl. No.: 11/155,418

(22) Filed: Jun. 17, 2005

Related U.S. Application Data
(60) Provisional application No. 60/580,517, filed on Jun. 17, 2004.

(51) Int. Cl. G02B 6/04

(52) U.S. Cl. 385/115

(57) ABSTRACT

A fiberoptic device is provided which is adapted to be used with a light source. The fiberoptic device comprises a core material and a cladding material having a lower refractive index than the core material, and means to operably connect the fiberoptic device to a light source. The fiberoptic device has a tapered input end to increase the intensity and uniformity of light transmitted through the device.

### CROSS-REFERENCE TO RELATED APPLICATION

This application claims the benefit of U.S. provisional application Ser. No. 60/580,517, filed Jun. 17, 2004, which is hereby incorporated herein in its entirety by this reference.

### BACKGROUND OF THE INVENTION

Fiberoptic devices are often used by dental practitioners in various dental procedures, including dental bleaching or dental restoration work. Fiberoptic devices are also used in industrial applications for curing composites. The fiberoptic devices are used in conjunction with a light source to direct a high intensity light beam to a selected area, such as at a patient's teeth or at a particular area of a patient's teeth. The present invention is an improved device which can increase the amount and intensity of light delivered to a selected area. The fiberoptic device can be used for various dental procedures, for curing composites used in industrial applications, or for any other application requiring a light guide for transmitting high intensity light.

Dental bleaching is a procedure performed by dental practitioners to whiten the teeth of patients. The dental bleaching treatment requires a high intensity light beam which can be focused on the patient's teeth. The light beam is used in combination with a peroxide gel or other bleaching substance applied to the teeth. In addition, many dentists have light curing systems in their offices that are used to cure epoxies or other materials used in restorative procedures.

The systems used to produce a light beam are generally of three types: (1) gun-type units, (2) base units with a flexible light guide extending from the base unit, and (3) wand-style units. Gun-type units typically include a light source (such as, for example, halogen bulb, LED, laser, or plasma arc), a power supply and a cooling fan, with a receptacle for connecting a fiber optic attachment to focus the light on a small area, such as a person's teeth, a single tooth, or to cure a composite in industrial applications such as attaching chips to a circuit board. Base units include a power supply and light source (typically an arc lamp or laser) connected by a flexible fiber optic or liquid light guide to a fiber optic output device. A wand-style unit typically includes a light source, such as an LED, which transmits light through a window at the tip of the wand. A wand-style unit can use a fiberoptic device on the tip, or the tip can be tapered to increase the intensity of the light directed to a work area.

As shown in FIG. 1, the light source in current light curing systems typically comprises a light source, such as an LED, surrounded by a reflector. The reflector reflects light from the LED toward the surface of a light probe where the input end of the probe is outside of the reflector. The input end of the probe defines a plane that is perpendicular to the light source, with the input end of the fibers also perpendicular to the light source. The numerical aperture (NA) range of the fiber optic probe having this configuration is typically between 0.5 to 0.7.

In some prior probes, the output end of the probe is tapered to a smaller diameter than the input end of the probe to attempt to focus the light collected by the probe in a smaller area, thereby increasing the intensity of the light beam emitted from the probe. While this configuration has resulted in some increase in the intensity of the light beam being delivered through the fiberoptic probe, it would be advantageous to have a fiberoptic device which could be attached to existing light curing systems and which could increase the intensity and uniformity of light delivered to a patient's teeth. It would also be advantageous to have a fiberoptic device that can transmit light more efficiently than existing devices.

Accordingly, it is an object of the present invention to provide a fiberoptic device that can deliver increased amounts of light or which can deliver light at an increased intensity compared to prior fiberoptic devices and that can be used with existing light curing systems. Other objects and advantages of the present invention will be apparent to those skilled in the art based upon the detailed description of embodiments of the invention set forth below.

### SUMMARY OF THE INVENTION

The present disclosure provides a fiberoptic device which may be adapted to be used with existing light sources and deliver increased amounts of light or deliver light at an increased intensity compared to prior fiberoptic devices. In one embodiment, a fiberoptic device for use with a light source includes a light guide including a core and a cladding covering the outer surface of the core. The cladding has a lower refractive index than the core. The light guide comprises a main body portion intermediate an output end and an input end. The input end is generally cylindrical having an input face for receiving light from a light source and a tapered portion. The diameter of the tapered portion increases with distance from the input end and the tapered portion terminates at the main body portion of the fiberoptic device.

The present disclosure also provides a fiberoptic device to increase amounts of light or to deliver light at an increased intensity using prior art fiberoptic devices. The device includes a light guide having a core and a cladding covering the outer surface of the core having a lower refractive index than the core. The light guide comprises an input end generally cylindrical having an input face for receiving light from a light source and a tapered portion. The diameter of the tapered portion increases with distance from the input end and the tapered portion terminates at an output end defining the fiberoptic device. In this embodiment, the fiberoptic device is a collector element disposed between the light source and the prior art fiberoptic device to increase the intensity of light emitted from an output end of the prior art fiberoptic device. Moreover, the smaller diameter of an input end of the collector element allows the input end to be in closer proximity to the light source than without a tapered portion.

The present disclosure also provides a fiberoptic device having a configuration that allows the device to be located more proximate the light source where light intensity is greater. The shape of the input taper of the fiberoptic device allows collection of light that would normally be reflected off of the surface of the device or absorbed by the fibers themselves.

It should be noted that locating a standard fiber optic probe closer to the light source does not necessarily result in light with a greater intensity coming out of the output end of the probe. In this case, the light is condensed in the center of the probe creating a so-called “hot-spot”. Therefore, uniformity of output is compromised when attempting to collect more light using prior probes.

The fiberoptic device (e.g., reverse collector) of the present disclosure is located proximate the light source to collect more intense light. The fiberoptic device of the present disclosure has the ability to collect this more intense light while retaining greater output uniformity than the standard fiber optic probe, and in the process, increases the useful intensity of the light source.

Additional features, functions and advantages associated with the disclosed fiberoptic devices and methods will be apparent from the detailed description which follows, particularly when reviewed in conjunction with the figures appended hereto.

### BRIEF DESCRIPTION OF THE DRAWINGS

So that those having ordinary skill in the art to which the subject invention appertains will more readily understand the subject invention, reference may be had to the drawings, wherein:

FIG. 1 is a side view of a prior art fiberoptic device showing the orientation of the end of the fiberoptic device relative to the light source and reflector.

FIG. 2 is a side view of a reverse collector fiberoptic device of the present invention showing the tapered input end of the device and the position of the input end relative to the light source.

FIG. 3a is an end view of a single element glass reverse collector fiberoptic device.

FIG. 3b is an end view of an acrylic reverse collector fiber optic device.

FIG. 4 is an end view of a multi-array glass reverse collector fiberoptic device.

FIG. 5 is a magnified view of Section A from FIG. 4.

FIG. 6a is a side view of an embodiment of the reverse collector fiberoptic device with an attached connector means.

FIG. 6b is a side view of an embodiment of the reverse collector fiberoptic device with a second attached connector means.

FIG. 7 is a side view of an embodiment of the reverse collector fiberoptic device with a tapered output end.

FIG. 8 is a side view of an embodiment of the reverse collector fiberoptic device with a wafer fixed to the input end of the device.

FIG. 9 is a side view of an embodiment of the reverse collector fiberoptic device in which the face of the output end is perpendicular to the center line of the main body of the device.

FIG. 10 is a side view of an embodiment of the invention comprising a reverse collector element used in conjunction with a wand-type light source or with an existing prior art fiberoptic device.

FIG. 11 shows a light source as a light gun with an acrylic fiberoptic device.

FIG. 12 shows a light source and a glass fiberoptic device and a connector for attaching the fiberoptic device to the light source.

FIG. 13 shows the tapered device of FIG. 9 in conjunction with connecting means for operable connection with a light source.

FIG. 14 shows the tapered device of FIG. 9 in conjunction with connecting means for operable connection with a light source.

FIG. 15 shows embodiments in which the taper is in the form of a collector adaptor element unattached to the fiberoptic device.

FIG. 16 shows embodiments in which the taper is in the form of a collector adaptor element unattached to the fiberoptic device.

FIG. 17 illustrates a tapered adaptor element located on top of a printed card showing the magnification effect of the tapered element.

### DETAILED DESCRIPTION OF PREFERRED EMBODIMENTS

The present invention relates to a fiberoptic device adapted to be used with a light source such as a light curing system. The fiberoptic device may be comprised of a single element, or it may be a multi-array of fiber optic elements. A connecting means may be fixed to the fiberoptic device to permit the device to be connected to a light curing system or a dental bleaching system. The present invention also relates to methods of making the fiberoptic device. The fiberoptic device may be made of glass or a light transmitting plastic material such as acrylic. As described in detail below, a glass device is made by drawing a glass rod or glass fibers to the desired shape. Light transmitting plastic may be molded to the desired shape.

The fiberoptic device includes means for transmitting light from a light source to an area to be illuminated. The light transmission means preferably comprises a light guide made of an inner glass core and an outer cladding, or a plurality of glass fibers with each fiber comprising a glass core and an outer cladding. As described below, the light transmission means is constructed and shaped with a tapered input end to increase the amount and quality of incident light that is transmitted through the fiberoptic device. The diameter of the fiberoptic device increases through a tapered portion extending from the input end to the main body of the device. Light is transmitted through the main body of the device to the output end. If desired, the output end of the device may be tapered to a diameter less than the diameter of the main body of the device to further increase the intensity of the delivered light or to focus the light on a narrower area.

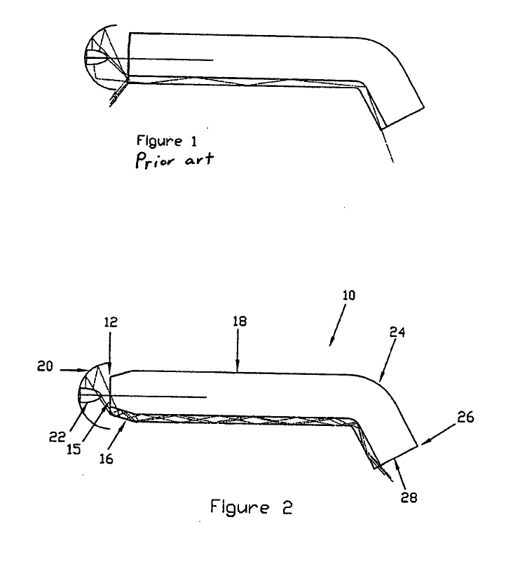

The tapered input end of the fiberoptic device unexpectedly results in increased transmission of light from the light source as compared to prior art devices having a uniform diameter from the input end through the main body of the device, such as the prior art fiberoptic device shown in FIG. 1. The tapered input end provides an improved angle for entry light into the fiberoptic device. A fiberoptic device having a tapered input end as described below is sometimes referred to herein as a “reverse collector fiberoptic device.”

Referring to FIG. 2, in one embodiment of the invention, the reverse collector fiberoptic device, indicated generally by the reference number (10), has a cylindrically shaped input end (12) which has a diameter that is less than the diameter of the reflector (20) that typically surrounds the light source (22) at the light output end of a light curing system, such as the light output end of a gun-type curing device or the light output end of a light guide attached to a base. The fiberoptic device is attached to the light source with the input end of the device in close proximity to the light source. The taper on the input end of the device increases the acceptance angle of the fibers for light, thereby increasing the power and uniformity of the light that enters the fiberoptic device.

The input end of the reverse collector fiberoptic device has a transition portion (16) in which the diameter of the fiberoptic device gradually increases in the direction from the input end (12) towards the cylindrical main body (18) of the fiberoptic device. The main body (18) has a curved section (24) which directs the output end (26) of the reverse collector fiberoptic device at an angle from the centerline of the main body (18) of the device. The curved section (24) allows easier handling and use of the device for directing the light beam in the mouth of a patient. The invention is not limited in this regard, however, and reverse collector fiberoptic devices without a curved section (24) at the output end are within the scope of the invention, as well as for directing a light beam for other intended purposes other than in the mouth of a patient.

In this embodiment of the invention, the curved section (24) of the fiberoptic device may be at any desired angle for the intended use, while the diameter of the input end (12) and the main body (18) may be any desired diameter for use with a particular type of light source. In a preferred embodiment, the center line of the body of the device through the end face defining output end (26) forms an angle of about 60° from the centerline of the main body of the device, while the input end (12) of the fiberoptic device has a diameter of about 8 mm, and the main body (18) has a diameter of about 11 mm. The tapered input end (12) has a taper angle of about 10°.

The face (15) of the input end (12) of the reverse collector fiberoptic device may be flat, curved or faceted as desired to distribute the light entering the device from the light source (22). An optical coating may be applied to the face (15) to enhance performance. In addition, the face (15) of the input end (12) can be formed in a shape to better fit the light pattern emitted from the light source (22). The diameter of the face (15) of the input end (12) is generally selected to be compatible with the light source (22). Any appropriate taper angle or length of taper may be used on the input end (12). In preferred embodiments, the taper angle is between about 2° to about 30° relative to a centerline of the main body (18).

The reverse collector fiberoptic device (10) may be comprised of a single element, or it may be composed of a multi-array of fiber optic elements, as illustrated in FIG. 2. A single element device may be made of glass or an appropriate light-transmitting plastic, such as an acrylic. As shown in FIG. 3a, a glass single element reverse collector fiberoptic device is comprised of a core material (30) covered by a cladding (32). The cladding (32) may be comprised of a single layer of one material, such as glass, or an inner cladding material and an outer cladding material, or a single cladding material and an outer coating. The cladding material is preferably glass, and is selected to have a refractive index lower than the refractive index of the core such that most of the light impinging upon the cladding is reflected back into the core material. This minimizes light losses from the fiberoptic device and increases the efficiency of the fiberoptic device in transmitting light. Outer coatings can be selected to impart desired properties to the fiberoptic device. Selection of materials having appropriate refractive indexes and selection of appropriate outer coatings to impart desired properties are well known to those skilled in the art. Coatings may be black, clear, amber, or any other appropriate type of coating. As shown in FIG. 3b, where a single element device is made from a light-transmitting plastic, such as an acrylic, no outer coating is required.

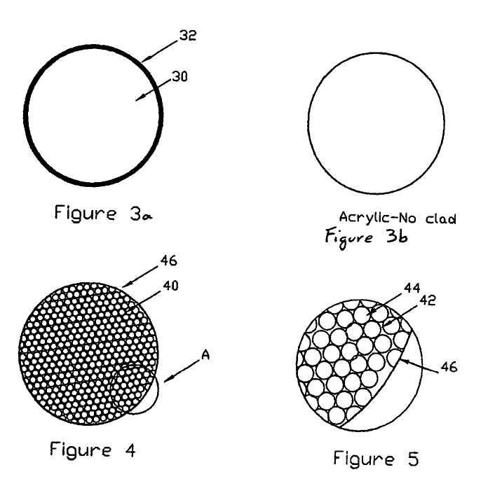

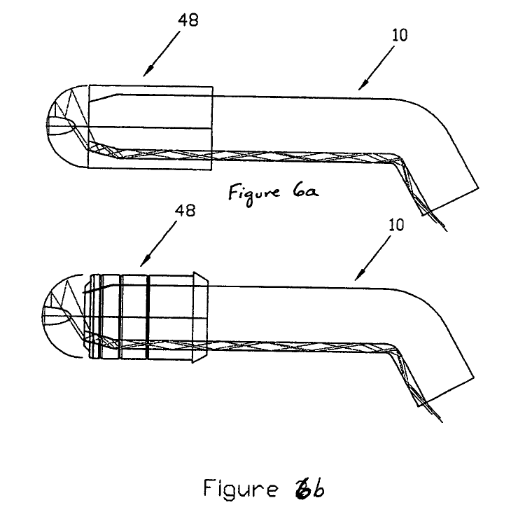

As shown in FIGS. 4 and 5, the multi-array glass fiberoptic device is comprised of a plurality of individual fiber optic elements (40). Each fiber optic element (40) is comprised of a glass core (44) and a cladding (42). The cladding (42) for the fiber optic elements can be comprised of any of the materials discussed above for the single element glass fiberoptic device, and is chosen to have a lower refractive index than the core material to reflect a large percentage of the light impinging on the cladding back into the core, minimizing losses of light and increasing the efficiency of light transmission. An exposed periphery defining the multi-array fiberoptic device can be covered with a cladding material or envelope (46). Alternatively, the outer exposed periphery of the multi-array fiberoptic device may be coated as discussed above for the single element device.

The reverse collector fiberoptic device, whether comprised of a single element or the multi-array device, may be enclosed in a housing comprised of plastic, metal or any other appropriate material known to those skilled in the art.

Referring again to FIG. 2, the faces (15, 28) of the input end (12) and output end (26), respectively, of the reverse collector fiberoptic device are ground and polished to the desired finish. For example, the input or output ends may be polished to an optical polish or they may have a matte finish depending upon the intended application of the device. The ends of the device may be coated to impart desired properties. For example, an anti-reflective coating or a filter coating may be applied to either end of the reverse collector fiberoptic device. The invention is not limited in this regard, however, and any appropriate coating known to those skilled in the art may be applied to either end (12, 26) of the device (10) to impart desired physical or optical properties.

As shown in FIGS. 6a and 6b, the input end (12) of the reverse collector fiberoptic device (10) may be coupled to a connecting means (48) to allow the device to be connected to a light curing system. The connecting means (48) can be any appropriate type of adapter or connector known to those skilled in the art for connecting a light output device to a light system (e.g., device (10) to light source). The connecting means (48) is sized and shaped to be received in a corresponding adaptor or connector at the light output end of a light system. For example, the connector on the fiberoptic device shown in FIG. 6a or 6b may be sized and shaped to be received and held in a gun-type light curing device. In another embodiment of the invention, the connection device is a separate piece from the fiberoptic device, and is used to connect the fiberoptic device to a light source.

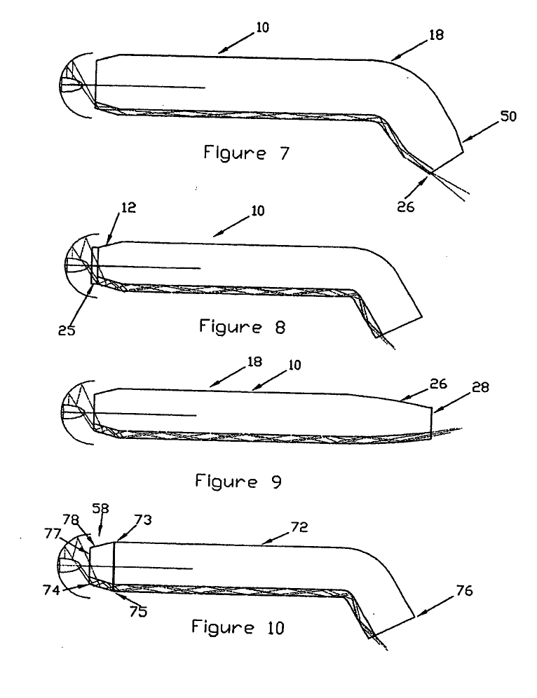

Referring now to FIG. 7, the reverse collector fiberoptic device (10) may include a tapered portion (50) from the main body (18) to the output end (26) of the device to further increase the intensity of the light emitted from the output end (26) of the fiberoptic device. The tapered portion (50) on the output end (26) may have any desired length of taper or taper angle. As shown in FIG. 9, in another embodiment, the fiberoptic device (10) does not include a curved section, and the endface (28) of the output end (26) of the fiberoptic device (10) is perpendicular to the center line of the body (18) of the device.

As shown in FIG. 8, the reverse collector fiberoptic device (10) may include a clad rod or fiberoptic wafer (25) at the input end (12) of the device.

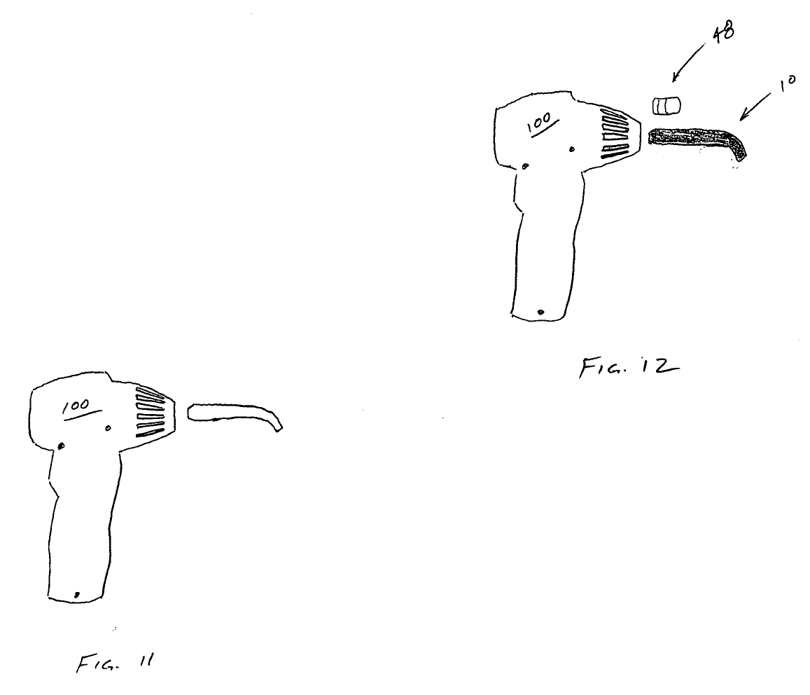

As shown in FIG. 10, in another embodiment of the present invention, which is particularly useful to improve the intensity of light output from a wand-style light source or for use with an existing fiberoptic device having a standard input end, the reverse collector fiberoptic device is a collector adapter element (58) that is sized and shaped to be received at the output end of a wand-style light source or in a connector between the output end of a light source and an existing fiberoptic device having a standard input end (73). In this embodiment, the collector element (58) may be used in conjunction with an existing fiberoptic device (72) to increase the intensity of the light emitted from the output end (76) of the fiberoptic device (72). In this embodiment of the invention, the fiberoptic collector element (58) has an input end (74), an output end (75) and a tapered portion (78). A face (77) defining the input end is inserted in the light system adjacent to the light source. The diameter of the input end (74) of the collector element (58) allows the input end (74) to be in close proximity to the light source.

The output end (75) of the collector element (58) has a diameter approximately equal to the diameter of the input end (73) of the existing fiberoptic device (72). Light from the light source enters the input end (74) of the collector element (58), travels through the collector element (58) to the output end (75), enters the input end (73) of the existing fiberoptic device (72), and exits through the output end (76) of the existing fiberoptic device (72). When used with a wand-style light source, the light exits from the output end (75) of the collector element (58) and is directed to a selected area, such as for example a tooth.

The input end (74) of the fiberoptic collector element (58) may have any appropriate diameter to allow the input end (74) to be located in close proximity to the light source. The length of the tapered portion (78) of the collector element (58) may be any length sufficient to be used with the desired light source. The collector element (58) may be comprised of a single fiber element (e.g., FIGS. 3a, 3b) or a multi-array of fiber elements (e.g., FIG. 4) as described above. The collector element (58) may have an outer coating to impart desired properties, or may be enclosed within a housing, and the input and output faces may be polished, coated or otherwise treated as described above.

FIGS. 11-17 show samples of various embodiments of fiberoptic devices of the present invention. Correspondence between the samples and the devices shown above are briefly described below in relation to each of the figures.

FIG. 11 illustrates a one piece device as illustrated in FIG. 3b. The one piece device is made of acrylic having a taper at the input end for operable communication with light source (100). In an exemplary embodiment, light source (100) may be used for curing of epoxies or other materials used in dental reconstruction.

FIG. 12 illustrates the device (10) of FIG. 2 with a separated connecting means (48) as in FIGS. 6a and 6b to connect the device (10) with light source (100).

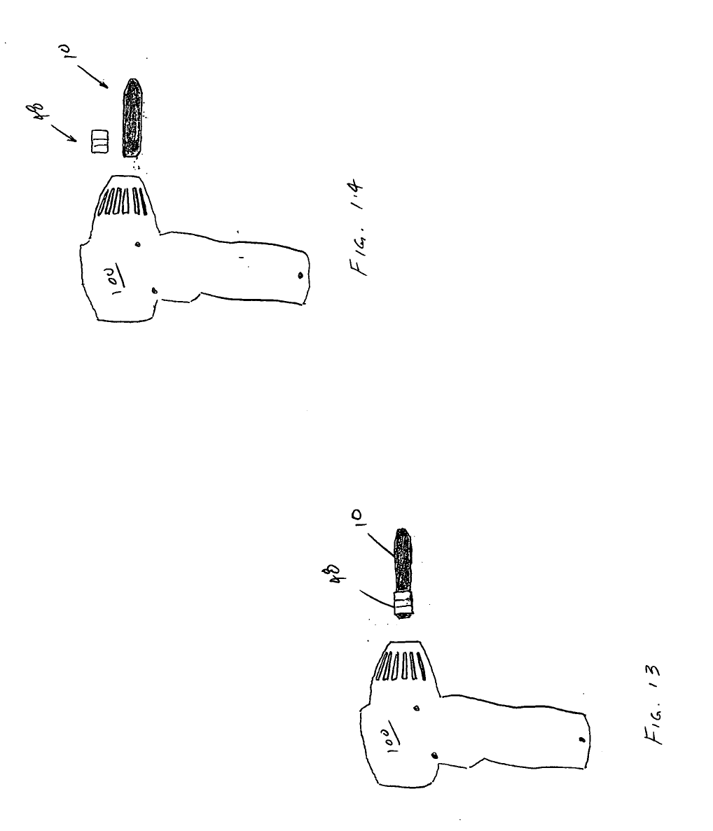

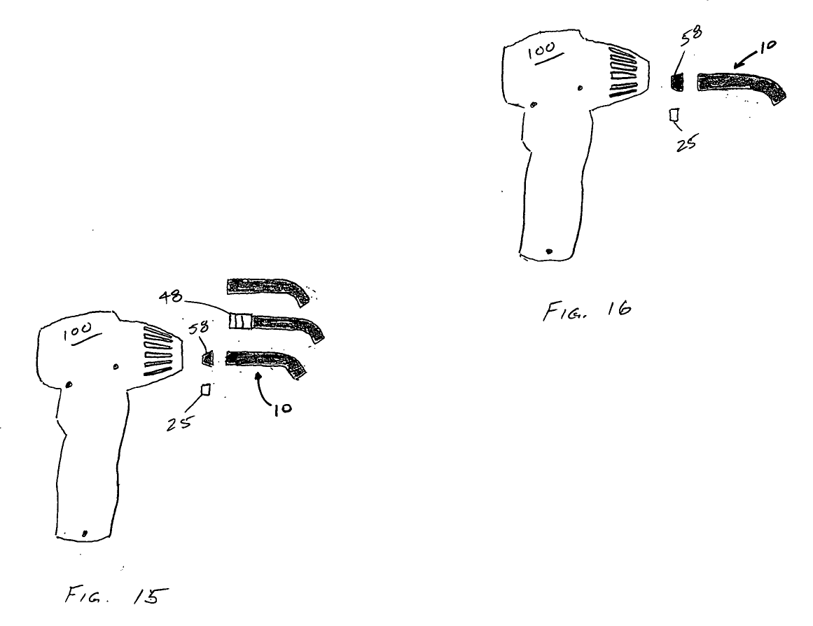

FIGS. 13 and 14 illustrate the tapered device (10) of FIG. 9 in conjunction with connecting means (48) for operable connection with light source (100).

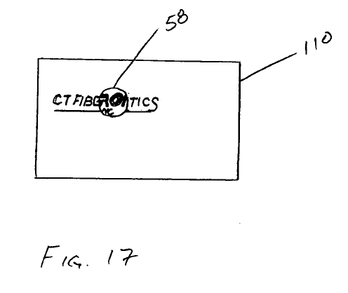

FIGS. 15 and 16 illustrate the collector adaptor element (58) unattached to the fiberoptic device (10). The adaptor element can be incorporated with the light source (100) itself or attached to the fiberoptic device (10). The two tapers shown in each figure may be fiberoptic or clad rod. In particular, a glass adaptor element (58) as in FIG. 10 is shown, as well as an acrylic clad rod or wafer (25) as in FIG. 8 is shown. FIG. 16 illustrates that either a tapered acrylic clad rod (25) or tapered glass adaptor element (58) may be used with the prior art device of FIG. 1 providing a tapered input to the prior art device.

FIG. 17 illustrates a tapered adaptor element (58) located on top of a printed card (110). The taper located on top of the printed card (110) illustrates magnification of the print located below and aligned with the taper.

The reverse collector fiberoptic device can be made as a continuous piece as in FIG. 2 (e.g., input taper and main body) or as in FIG. 9 (e.g., input taper, main body and output taper). Alternatively, the reverse collector fiberoptic device may be stacked as individual pieces, as in FIGS. 15 and 16, to accomplish the same result. In another alternative embodiment, the input taper itself (e.g., tapered adaptor element (58)) may be incorporated into the light source and a standard probe attached. In further alternative embodiments, it is contemplated that either tapered adaptor element (58) or an acrylic clad rod or wafer (25), as in FIGS. 15 and 16, may be incorporated directly into the light source (e.g., light gun).

The device of the present invention can be used for dental bleaching procedures, and it can be used with existing base units used for light curing of epoxies or other materials used in dental reconstruction. The device may be used with any type of light source known to those skilled in the art, such as a light source with a fiber optic light guide, a light source with a liquid light guide, or it may be connected directly to the light source, as in a gun-type light curing device or a wand-style light source. When using the device on a light guide, for example, the light guide can be of a greater NA than normally used and the device can gather light rays that are skewed and otherwise unused. In addition, as will be apparent to a person skilled in the art, a light source may be designed for use with the reverse collector fiberoptic device to further improve the intensity of the light transmitted by the device.

If a light transmitting plastic, such as an acrylic, is used for the device, the plastic is molded to the desired shape. The method for manufacturing the fiberoptic device using a glass is described below referring to FIGS. 2-4.

A single element or multi-element glass fiberoptic billet or rod is made. The single element billet is made using a glass core material and a cladding material selected to provide the desired qualities in the reverse collector fiberoptic device. The material used for the cladding (32) is preferably a material having a lower refractive index than the material used for the glass core (30) to retain scattered light within the core material. The cladding (32) is preferably provided in a hollow cylindrical shape or envelope. The invention is not limited in this regard, however, and the cladding (32) may be provided in any desired shape, or it may be coated or sprayed over the core (30) and fired to bond to the core (30).

The core material is placed within the cladding material, and the core (30) and cladding (32) are heated to produce the single element billet. While they are heated, the core (30) and cladding (32) are pressed together or pulled together under a vacuum to create a clean, consistent interface between the core material and the cladding material. The single element billet is preferably cylindrical, and it may be of any desired diameter required to manufacture a fiberoptic device having a main body portion with the desired dimensions. In a preferred embodiment, the diameter of the billet is approximately 1.3 inches (e.g., 33 mm).

For a multi-array fiberoptic device, a billet may be formed using a plurality of small diameter glass fibers (40). The glass fibers (40) are each comprised of a glass core material surrounded by a cladding material having a lower refractive index than the core material to reflect scattered light back into the core (44). A multi-array billet is made by packing the plurality of fibers (40) into an envelope (46). The envelope (46) and fibers (40) are heated and pressed or pulled together under a vacuum to create a multi-array billet comprised of fibers. Alternatively, the individual fibers can be stacked in a mold and pressed together to form a block. The block can be machined into a billet or rod shape.

For a reverse collector fiberoptic device comprised of glass, the glass must be heated and drawn to the desired shape. After the glass billet has been formed, the billet is heated and the end of the billet is drawn to create a tapered reduction in the diameter of the billet. The end of the billet is drawn to create the desired reduction in the diameter of the billet at the desired taper angle. After the end of the billet has been drawn to the desired taper and diameter, it is cut in the taper region to provide an input end with improved acceptance angle for incoming light. The taper is cut at an appropriate place to provide a frustoconical input end having the desired diameter.

If desired, the output end (26) of the device may be heated and bent at a location near the output end of the reverse collector fiberoptic device to form a curved section (24) with the face of the output end (26) at a selected angle from the centerline of the body portion (18) of the device. Also, the output end (26) may be tapered by heating the output end (26), drawing the output end (26) to the desired taper, and cutting the device at a point where the output end (26) has the desired diameter.

The face (15) of the input end (12) of the fiberoptic device may be flat, convex, concave or faceted. The faces of the input end (12) and the output end (26) are ground and polished. A coating can be applied to face of the input end (12) or the output end (26) if desired to enhance the properties of the device.

Connecting means (48), such as an adapter or connector, may be fixed to the input end (12) of the fiberoptic device as in FIGS. 12-15. The connecting means (48) is selected to permit the device to be connected to a light source (100) of the desired type. Preferably, the adapter or connector can be connected to a light curing device as illustrated in FIGS. 11-16. The adapter or connector can be fixed to the input end (12) using any method known to those skilled in the art. Preferably, the adaptor or connector is glued to the input end (12) of the fiberoptic device (10).

A housing or other type of protective covering can be fixed to the outer surface of the bleaching device. The invention is not limited in this regard, and the device does not necessarily have to include a housing, as some light sources are equipped to accept a probe without a housing. The housing can be made from plastic, metal or any other material known to those skilled in the art. Preferably, the housing is made from a material that can be autoclaved.

As will be recognized by those of ordinary skill in the art based on the teachings herein, numerous changes and modifications may be made to the above-described embodiments of the present invention without departing from its spirit or scope. Accordingly, this detailed description of preferred embodiments is to be taken in an illustrative rather than a limiting sense.

1. A fiberoptic device for use with a light source, comprising:
a light guide including a core and a cladding covering the outer surface of the core and having a lower refractive index than the core, wherein the light guide comprises a main body portion intermediate an output end and an input end, the input end having an input face for receiving light from a light source and a tapered portion, the diameter of the tapered portion increases with distance from the input end and the tapered portion terminates at the main body portion of the fiberoptic device.

2. The fiberoptic device of claim 1, wherein the input face defining the input end is one of flat, curved and faceted.

3. The fiberoptic device of claim 2, wherein the input face defining the input end is curved being one of convex and concave.

4. The fiberoptic device of claim 1, wherein the core is one of glass and plastic.

5. The fiberoptic device of claim 4, wherein when the core is plastic, the cladding is defined by an exposed surface of the plastic core.

6. The fiberoptic device of claim 1, wherein the tapered portion has a taper angle of between about 2° to about 30° relative to a centerline defining the main body portion.

7. The fiber optic device of claim 1, wherein the light guide is one of a single element device and a multi-array device.

8. The fiberoptic device of claim 1, wherein the light guide includes a plurality of cores and corresponding cladding.

9. The fiberoptic device of claim 1, further comprising an outer housing.

10. The fiberoptic device of claim 9, wherein the housing includes one of a cladding material and a coating material.

11. The fiberoptic device of claim 1, wherein the main body portion includes a curved section proximate the output end.

12. The fiberoptic device of claim 11, wherein the curved section forms an angle of about 60° with a centerline of the main body portion through an end face of the output end.

13. A fiberoptic device for use with a light source, comprising:
a light guide including a core and a cladding covering the outer surface of the core and having a lower refractive index than the core, wherein the light guide comprises an input end having an input face for receiving light from a light source and a tapered portion, the diameter of the tapered portion increases with distance from the input end and the tapered portion terminates at an output end defining the fiberoptic device.

14. The fiberoptic device of claim 13, wherein the input face defining the input end is one of flat, curved and faceted.

15. The fiberoptic device of claim 13, wherein the core is one of glass and plastic.

16. The fiberoptic device of claim 15, wherein when the core is plastic, the cladding is defined by an exposed surface of the plastic core.

17. The fiberoptic device of claim 13, wherein the tapered portion has a taper angle of between about 2° to about 30° relative to a centerline defining the tapered portion.
